(19) United States
(12) Patent Application Publication
(10) Pub. No.: US 2002/0039964 A1
(43) Pub. Date: Apr. 4, 2002

(54) Ceramic catalyst body, ceramic support and their production methods

(76) Inventors: Masakazu Tanaka, Okazaki-city (JP); Tosiharu Kondo, Toyoake-city (JP); Tomohiko Nakanishi, Nishio-shi (JP); Kazuhiko Koike, Nishio-shi (JP)

Correspondence Address: LAW OFFICE OF DAVID G POSZ, 2000 L STREET, N.W., SUITE 200, WASHINGTON, DC, 20036, US

(21) Appl. No.: 09/960,361

(22) Filed: Sep. 24, 2001

(30) Foreign Application Priority Data
Sep. 29, 2000 (JP) 2000-297976
Aug. 6, 2001 (JP) 2001-237925

(51) Int. Cl. B01J 23/56

(52) U.S. Cl. 502/304; 502/334; 502/313

(57) ABSTRACT

The object of the present invention is to improve the catalyst performance of a ceramic support that enables a catalyst component to be loaded directly, prevent thermal degradation and so forth, and enhance durability.

In the present invention, when producing a catalyst body by loading a catalyst onto a ceramic support having a large number of pores that enable a catalyst to be loaded directly onto a base ceramic surface, the mean particle size of the catalyst particles is made to be 100 nm or less, and preferably 50 nm or less. As a result of reducing particle size, in addition to making it possible for the catalyst particles to be highly dispersed, the catalyst particles can be reliably retained in the microscopic pores, thereby suppressing aggregation and degradation caused by thermal vibration and so forth.

### BACKGROUND OF THE INVENTION

1. Field of the Invention

The present invention relates to a ceramic catalyst body and ceramic support used for catalyzing the purification of automobile engine exhaust gases, and their production methods.

2. Description of the Related Art

Exhaust gas purification catalysts in which a monolithic support surface comprised of highly thermal shock resistant cordierite is coated with γ-alumina and loaded with a precious metal catalyst have been widely used in the prior art as catalysts for purification of exhaust gas. The reason for forming a coating layer is that the specific surface of the cordierite is small and if cordierite is used alone, it is not possible to load the required amount of catalyst component. Therefore, a material having a high specific surface area like γ-alumina is used to increase the surface area of the support.

However, coating the cell wall surface of the support with γ-alumina invites an increase in heat capacity due to the increased weight. Although studies have been made in recent years involving decreasing heat capacity by reducing the thickness of the cell walls in order to activate the catalyst at an early stage, the effect of this is diminished considerably due to the formation of a coating layer. In addition, since the opening area of each cell decreases, pressure loss increases thereby resulting in the problem of the coefficient of thermal expansion increasing beyond that in the case of using cordierite alone.

Therefore, methods for improving the specific surface area of cordierite itself have been studied in the past (for example, Japanese Examined Patent Publication No. 5-50338). The resulting methods were not practical due to decreased strength resulting from destruction of the crystal lattice of the cordierite caused by acid treatment and heat treatment. Therefore, the object of the present invention is to find a ceramic catalyst body, ceramic support and their production methods having a high degree of practicality by being able to demonstrate superior catalyst performance over a long period of time.

### SUMMARY OF THE INVENTION

According to a first aspect of the invention, the ceramic catalyst body of the present invention comprises the loading of a catalyst onto a ceramic support having a large number of pores that enable the catalyst to be loaded directly onto a base ceramic surface, wherein the mean particle size of the above catalyst particles is 100 nm or less.

Catalyst degradation occurs due to the movement and aggregation of particles weakly bonded to the support due to thermal vibration and so forth. In the constitution of the present invention in which catalyst is directly loaded into microscopic pores in the ceramic support, since catalyst particles are tightly held in the microscopic pores, it is effective to reduce catalyst particle size, and when the mean particle size is reduced to 100 nm or less in particular, it is highly effective in preventing movement of the particles. In addition, by highly dispersing the microscopic catalyst particles on the support surface, catalyst performance improves. Accordingly, thermal degradation can be prevented, heat resistance can be significantly improved, and a high degree of catalyst performance can be demonstrated over a long period of time.

In a second aspect of the invention, the mean particle size of the above catalyst particles should preferably be made to be 50 nm or less, which is highly effective in improving catalyst performance along with preventing thermal degradation.

In a third aspect of the invention, the above pores are specifically composed of at least one type of defect in the ceramic crystal lattice, microcracks in the ceramic surface and deficits in the elements that compose the ceramic. These pores are small, having a diameter or width or 100 nm or less, and allow the loading of catalyst particles while maintaining the strength of the base ceramic.

In a fourth aspect of the invention, reducing the width of the above microcracks to 100 nm or less is preferable in terms of securing support strength.

In a fifth aspect of the invention, the above pores should have a diameter or width equal to 1000 times or less the diameter of the catalyst ions that are loaded in order to allow the loading of catalyst component, and at this time, if the number of the above pores is 1×10¹¹/L or more, an amount of catalyst component similar to that in the prior art can be loaded.

In a sixth aspect of the invention, a heat-resistant ceramic having cordierite for its main component, for example, is preferably used for the above base ceramic. At this time, by substituting a portion of the constituent elements of the cordierite with metal elements having a different valence, oxygen defects or lattice defects are formed, and these can be used as the above pores.

In this case, as in a seventh aspect of the invention, the above defects are composed of at least one type of oxygen defect and lattice defect. If 4×10⁻⁶% or more of cordierite crystals having one or more of the above defects are contained in the unit crystal lattice of the cordierite, an amount of catalyst component similar to that in the prior art can be loaded.

An eighth aspect of the invention is a ceramic support having a large number of pores that allow a catalyst to be loaded directly onto a base ceramic surface, wherein the above base ceramic has cordierite for its main component, and a metal element that is substituted for constituent elements of the cordierite is at least one type selected from Fe, Co, Ti, Zr, Ga, Ca, Y, Mo, Ge, W and Ce.

In a ninth aspect of the invention, among the specific constituent elements of the cordierite, at least one type of Fe, Co, Ga, Mo or W should be used as the substitution element of Si, at least one type of Ti, Ge, Zr or Mo should be used as the substitution element of Al, and at least one type of Fe, Ga, Ge, Mo, Ce or W should be used for the substitution element of Mg. In the case of substituting specific metal elements for these specific constituent elements, it is highly effective in preventing decreased performance caused by thermal degradation.

A tenth aspect of the invention is a ceramic support having a large number of pores that allow a catalyst to be loaded directly onto a base ceramic surface, wherein the above base ceramic has cordierite for its main component, and a metal element that is substituted for constituent elements of the cordierite is at least one type selected from transition metals.

In an eleventh aspect of the invention, at least one type of metal selected from Ca, Ti, Cr, Mn, Fe, Co, Ni, Cu, Zn, Ga, Ge, Sr, Y, Zr, Nb, Mo, In, Sn, Ba, La, Ce, Pr, Nd, Hf, Ta and W can be used for the above transition metals. By loading catalyst into pores formed by substituting with these metal elements, catalyst performance can be effectively demonstrated.

In a twelfth aspect of the invention, the above large number of pores are disposed evenly on the surface of the above base ceramic. At this time, since ceramic particles are uniformly dispersed on the support surface, catalyst performance can be improved.

In a thirteenth aspect of the invention, the above large number of pores are disposed concentrated on the surface layer portion of the above base ceramic. Since pores formed at deep sites from the surface do not adequately contribute to loading of catalyst, and have little opportunity to contact gas introduced into the support, by forming defects and cracks, etc. serving as pores on the surface layer portion of the base ceramic in a concentrated manner, the amount of catalyst loaded on the support surface increases and the opportunities for contact with introduced gas increase, thereby improving catalyst performance.

A fourteenth aspect of the invention is a ceramic catalyst body comprising loading a catalyst onto the ceramic support described in the eighth to tenth aspects of the invention. As described above, when the ceramic support of the eighth and ninth aspects of the invention is used, it is effective in improving the performance of the ceramic catalyst body, and when the ceramic support of the tenth aspect of the invention in particular is used, it is highly effective in suppressing thermal degradation.

In a fifteenth aspect of the invention, catalyst particles that bond weakly with the above support are removed in advance from the above loaded catalyst in the ceramic catalyst body described in any of the first, third, fourth, sixth, twelfth or fourteenth aspects of the invention. As a result of removing weakly bonded catalyst particles, the movement of catalyst particles is suppressed thereby making it possible to inhibit decreases in catalyst performance and maintain initial performance.

A sixteenth aspect of the invention is a method for producing a ceramic support having a large number of pores that allow catalyst to be loaded directly on a base ceramic surface, wherein defects formed by substituting a portion of the constituent elements of the above base ceramic with metal elements having a different valence are used for the above pores. At this time, after adding and mixing a solution of the above metal elements having a different valence to the starting material of the above base ceramic to form the above pores, the base ceramic is sintered to obtain the above ceramic support. When a solution is used to which substitution elements have been added, since the substitution elements are added as ions, it becomes possible to reduce the diameter of the particles and increase dispersion, thereby greatly improving catalyst performance.

A seventeenth aspect of the invention is a production method of a ceramic support having a large number of pores that allow catalyst to be loaded directly on a base ceramic surface, wherein defects formed by substituting a portion of the constituent elements of the above base ceramic with metal elements having a different valence are used for the above pores. At this time, after drying the extruded product of the above base ceramic, a coated film containing the above metal elements having a different valence is formed on its surface followed by sintering to obtain the above ceramic support. Instead of carrying out the addition of substitution elements during raw material preparation of the above base ceramic, the extruded product can be dried followed by coating a solution containing the above metal elements having a different valence onto the surface. This coated film reacts during sintering and forms defects that serve as pores.

An eighteenth aspect of the invention is a production method of a ceramic catalyst body comprising loading a catalyst onto a ceramic support having a large number of pores that allow catalyst to be loaded directly onto a base ceramic surface, wherein after loading the above catalyst particles, those catalyst particles that weakly bond with the above support are removed by applying chemical, physical or electromagnetic force. If those loaded catalyst particles having weak bonding force that are susceptible to movement caused by thermal vibration and so forth are removed in advance, stable catalyst performance can be maintained for a long period of time and performance improves.

### BRIEF DESCRIPTION OF THE DRAWINGS

FIG. 1(a) is a graph showing the relationship between catalyst sintering temperature and catalyst particle size distribution, FIG. 1(b) is a graph showing the relationship between catalyst sintering temperature and catalyst particle size, and FIG. 1(c) is a graph showing the relationship between catalyst mean particle size and 50% purification temperature.

FIG. 2 is a drawing showing a test method for evaluating purification performance.

FIG. 3 is a graph showing the relationship between substitution elements and 50% purification temperature.

FIG. 4(a) is a drawing showing the ceramic support production process in the case of disposing pores concentrated in the support surface layer portion. FIG. 4(b) is a drawing showing the details of the process in which a coated film containing substitution elements is formed on the support surface layer portion.

### DESCRIPTION OF THE PREFERRED EMBODIMENTS

The following provides a detailed explanation of the present invention. In the present invention, a ceramic support having a large number of pores that allow a catalyst to be loaded directly onto a base ceramic surface is used, and a catalyst is loaded onto this ceramic support to obtain a ceramic catalyst body. Ceramic having for its main component cordierite in which the theoretical composition is represented with 2 MgO.2Al₂O₃.5SiO₂ is preferably used for the base material of the ceramic support, and this is formed into a honeycomb structure to obtain a ceramic support. Ceramics such as alumina, spinel, aluminum titanate, silicon carbide, mullite, silica-alumina, zeolite, zirconia, silicon nitride and zirconium phosphate can also be used in addition to cordierite. In addition, the structure is not limited to a honeycomb structure, but rather other shapes can also be used, including pellets, powder, foam, hollow fibers and fibers.

The ceramic support has a large number of pores that allow a catalyst to be loaded directly onto a base ceramic surface. More specifically, these pores consist of at least one type of defects within the ceramic crystal lattice (oxygen defects or lattice defects), microcracks in the ceramic surface and deficits in the elements that compose the ceramic, and allow loading of catalyst component without forming a coating layer having a high specific surface area such as γ-alumina. Since the diameter of the loaded catalyst ions is normally about 0.1 nm, if the pores formed on the surface of the cordierite have a diameter or width of 0.1 nm or more, catalyst component ions can be loaded, and in order to ensure the strength of the ceramic, the diameter or width of the pores is preferably as small as possible, and 1000 times or less than the diameter of the catalyst component ions (100 nm), and more preferably 1 to 1000 times (0.1 to 100 nm). The depth of the pores is preferably ½ their diameter or more (0.05 nm) in order to hold the catalyst component ions. In order to be able to load an amount of catalyst component equal to that of the prior art (1.5 g/L) with pores of this size, the number of pores should be 1×10¹¹/L, preferably 1×10¹⁶/L or more, and more preferably 1×10¹⁷/L or more.

Those pores formed on the ceramic surface that are defects in the crystal lattice consist of oxygen defects and lattice defects (metal vacant lattice point and lattice strain). Oxygen defects are defects resulting from a lack of oxygen for composing the ceramic crystal lattice, and allow catalyst component to be loaded in pores formed due to the evacuation of oxygen. Crystal defects are defects resulting from the incorporation of oxygen beyond that which is required to form the ceramic crystal lattice, and allow catalyst component to be loaded in pores formed by strain of the crystal lattice and metal vacant lattice points.

More specifically, if the cordierite honeycomb structure contains 4×10⁻⁶% or more, and preferably 4×10⁻⁵% or more, of cordierite crystals having at least one type of one or more oxygen defects or lattice defects in the unit crystal lattice, or contains 4×10⁻⁸ or more, and preferably 4×10⁻⁷ or more, of at least one type of oxygen defect or lattice defect per unit crystal lattice, the number of pores of the ceramic support is greater than or equal to the above required number. The following provides a detailed explanation of the pores and an explanation of their formation method.

In order to form an oxygen defect in the crystal lattice, a cordierite raw material containing an Si source, Al source and Mg source is formed as described in Japanese Patent Application No. 2000-104994, and after degreasing, a method can be employed in a sintering step in which (1) the sintering atmosphere is changed to reduced pressure or a reducing atmosphere, and either (2) the oxygen in the sintering atmosphere or starting raw material is made to be deficient by using a compound that does not contain oxygen for at least a portion of the raw materials and sintering in a low oxygen concentration atmosphere, or (3) substituting a portion of at least one type of constituent element of the ceramic other than oxygen for an element having a smaller valence by said reduction. In the case of cordierite, since the constituent elements have a positive charge in the manner of Si (4+), Al (3+) and Mg (2+), if these are substituted with an element having a smaller valence, the positive charge becomes deficient corresponding to the difference in valence with the substituted element and the amount substituted, and in order to maintain the electrical neutrality of the crystal lattice, oxygen having a negative charge (2−) is released resulting in the formation of an oxygen defect.

In addition, lattice defects can be formed by (4) substituting a portion of the ceramic constituent elements other than oxygen with an element having a larger valence than said elements. If at least a portion of the Si, Al and Mg that are the constituent elements of cordierite is substituted with an element having a larger valence than those elements, an excess positive charge results corresponding to the difference in valance with the substituted elements and the amount substituted, and in order to maintain the electrical neutrality of the crystal lattice, oxygen having a negative charge (2−) is incorporated beyond that which is necessary. The incorporated oxygen then acts as an obstacle and prevents the cordierite crystal lattice from being arranged in an orderly manner, resulting in the formation of lattice strain. Alternatively, in order to maintain electrical neutrality, a portion of the Si, Al and Mg is released, resulting in the formation of holes. The sintering atmosphere in this case is an air atmosphere, and an adequate supply of oxygen is provided. Furthermore, since the size of these defects is thought to be on the order of several angstroms or less, they cannot be measured as specific surface area using ordinary methods for measuring specific surface area such as the BET method that uses nitrogen molecules.

At least one type of transition metal selected from, for example, Ca, Ti, Cr, Mn, Fe, Co, Ni, Cu, Zn, Ga, Ge, Sr, Y, Zr, Nb, Mo, In, Sn, Ba, La, Ce, Pr, Nd, Hf, Ta and w can be used as metal elements that are substituted for the constituent elements of cordierite. More specifically, among the constituent elements of cordierite, it is more preferably to use at least one type selected from Fe, Co, Ga, Mo and W for the substitution elements of Si, at least type selected from Ti, Ge, Zr and Mo for the substitution elements of Al, and at least one type selected from Fe, Ga, Ge, Mo, Ce and W for the substitution elements of Mg. In the case of substituting these specific constituent elements with specific metal elements, it is highly effective in preventing decreases in performance caused by thermal degradation.

The number of oxygen defects and lattice defects is related to the amount of oxygen contained in the cordierite honeycomb structure, and in order to load the above-mentioned required amount of catalyst component, the amount of oxygen should be less than 47 wt % (oxygen defects) or greater than 48 wt % (lattice defects). If the amount of oxygen becomes less than 47 wt % due to the formation of oxygen defects, the number of oxygen atoms contained in the cordierite unit crystal lattice becomes lower than 17.2, and the lattice constant of the b₀ axis of the crystal axis of cordierite becomes lower than 16.99. In addition, if the amount of oxygen increases beyond 48 wt % due to the formation of lattice defects, the number of oxygen atoms contained in the cordierite unit crystal lattice becomes greater than 17.6, and the lattice constant of the b₀ axis of the crystal axis of cordierite becomes larger or smaller than 16.99.

A large number of microcracks in the ceramic surface among those pores having the ability to load catalyst are formed in at least either the amorphous phase or crystal phase of the cordierite honeycomb structure by applying thermal shock or shock waves. The cracks should be small in order to ensure the strength of the honeycomb structure, and have a width of about 100 nm or less, and preferably about 10 nm or less.

Heating followed by rapid cooling of the cordierite honeycomb structure is used as a method of applying thermal shock. Thermal shock should be applied after the cordierite crystal phase and amorphous phase have been formed in the cordierite honeycomb structure, and according to an ordinary method, after forming and degreasing a raw material for forming cordierite containing an Si source, Al source and Mg source, either a method in which the resulting material is sintered and the resulting cordierite honeycomb structure is re-heated to a prescribed temperature followed by rapid cooling, or a method in which the material is sintered and then rapidly cooled from a prescribed temperature in a cooling process, can be employed. In forming cracks by thermal shock, the difference between the heating temperature and the temperature after rapid cooling (thermal shock temperature difference) should normally be about 80° C. or more, and the size of the cracks becomes larger as the thermal shock temperature difference becomes larger. However, since it becomes difficult to maintain the form of the honeycomb structure if the cracks becomes excessively large, the thermal shock temperature difference should be about 900° C. or less.

In the cordierite honeycomb structure, the amorphous phase is present in the form of a layer around the crystal phase. If thermal shock is applied by heating the cordierite honeycomb structure followed by rapid cooling, since there is a difference in the coefficients of thermal expansion between the amorphous phase and crystal phase, thermal stress equivalent to this difference in coefficients of thermal expansion and the temperature difference of the thermal shock acts near the interface of the amorphous phase and crystal phase. If the amorphous phase or crystal phase becomes unable to withstand this thermal stress, microcracks form. The amount of microcrack formation can be controlled by the amount of the amorphous phase, and by adding trace elements (such as alkaline metal elements or alkaline earth metal elements) in the raw material, which are considered to contribute to the formation of the amorphous phase, in an amount greater than the normal amount, the amount of crack formation can be increased. In addition, shock waves such as ultrasonic waves or vibrations can also be applied instead of thermal shock, and when portions of low strength in the cordierite structure are no longer able to withstand the energy of the shock waves, microcracks form. The amount of microcrack formation in this case can be controlled by the energy of the shock waves.

Among those pores having the ability to load catalyst, deficits in elements that compose the ceramic can be formed by eluting cordierite constituent elements and impurities by a liquid phase method. For example, deficits are formed as a result of metal elements such as Mg or Al in the cordierite crystal, alkaline metal elements or alkaline earth metal elements contained in the amorphous phase or the amorphous phase itself eluting into high-temperature, high-pressure water, supercritical fluid or solution such as an alkaline solution, after which these element deficits become pores that are able to load catalyst. Alternatively, deficits can also be formed chemically or physically by a vapor phase method. For example, an example of a chemical method is dry etching, while an example of a physical method is sputter etching. The amount of pores can be controlled by the etching time or energy supplied.

A ceramic body in which a catalyst component has been loaded directly onto a ceramic support, in which is formed a large number of pores in its surface in the manner described above, is preferably used, for example, as an engine exhaust gas purification catalyst. In this case, precious metal catalysts such as Pt, Pd and Rh are normally used for the catalyst component. An cocatalyst such as CeO₂ can naturally also be used. Although water may be used as the solvent for loading the catalyst component, since the defects, cracks and other forms of pores formed in the ceramic support of the present invention are microscopic, it is more preferable to use a solvent having lower surface tension than water, such as ethanol or other alcohol-based solvent. Since solvents like water having high surface tension tend to have difficulty in penetrating into the pores, there are cases in which the pores may not be able to be adequately utilized. However, by using a solvent with low surface tension, the solvent is able to enter even microscopic pores, thereby making it possible to fully utilize the pores and load catalyst components at 0.5 g/L or more.

Here, the catalyst particles that are loaded should be in the form of fine particles in order to improve the catalyst performance of the ceramic catalyst body, suppress thermal degradation and improve heat resistance. Although thermal degradation occurs due to the movement and aggregation of particles weakly bonded to the support caused by thermal vibration and so forth, in the constitution of the present invention in which catalyst is directly loaded into microscopic pores in the surface of a ceramic support, the support surface tends to be comparatively flat, the distance between catalyst particles tends to be short, or during movement of weakly bonded particles, degradation proceeds easily by moving the adjacent catalyst particles. Therefore, by increasing the fineness of the catalyst particles and highly dispersing those fine particles, while also having the majority of those fine particles securely retained in the pores, catalyst performance can be enhanced and degradation can be suppressed. More specifically, if the mean particle size of the catalyst particles is 100 nm or less, and preferably 50 nm or less, nearly all of the loaded particles become entrapped in the pores and do not move. More preferably, the mean particle size is within the range of 10 to 35 nm. In addition, the particle size distribution of catalyst particles should approach a normal distribution, and the smaller the variation in particle size the better.

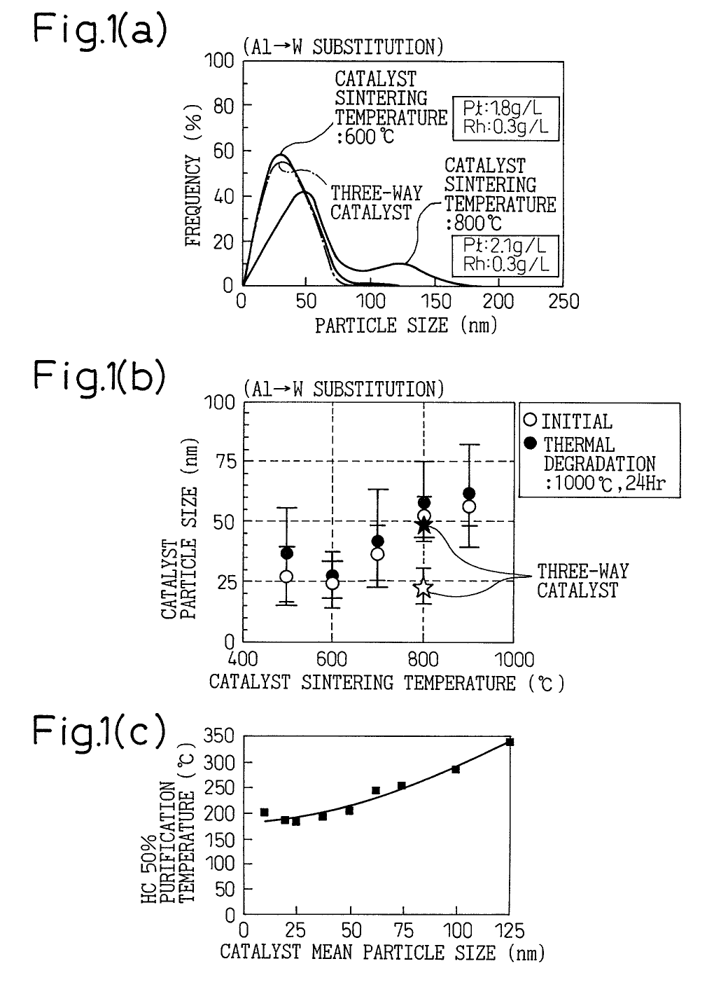

The particle size of catalyst particles can be controlled by adjusting the temperature when the catalyst component is loaded onto the ceramic support and sintered. FIG. 1(a) shows the particle size distribution when Pt and Rh were loaded on a ceramic support in which pores were formed serving as defects by substituting a portion of Al, which is the constituent element of the cordierite honeycomb structure, with W, followed by sintering at different temperatures. The ceramic support was obtained by substituting 10 wt % of the Al source among cordierite raw materials consisting of talc, kaolin, alumina and so forth with a W compound having a different valence, forming the mixture resulting from adding binder and so forth into a honeycomb shape, drying (at 90° C. for 6 hours) and sintering for 2.5 hours at 1300° C. and above. After immersing this in a solution containing Pt and Rh and drying, the resulting product was sintered at 600° C. or 800° C. followed by comparing and indicating the respective particle size distributions with a conventional three-way catalyst (in which the catalyst was loaded on a γ-alumina coating layer). The amount of catalyst loaded was 1.8 g/L of Pt and 0.3 g/L of Rh following sintering at 600° C., and 2.1 g/L of Pt and 0.3 g/L of Rh following sintering at 800° C.

As shown in FIG. 1(a), in the case of sintering at 800° C., although there is an increase in the number of large particles and there is considerable variation in size, in the case of sintering at 600° C., a normal distribution is demonstrated having a peak in the vicinity of 30 nm, and there are hardly any particles larger than 100 nm. The conventional three-way catalyst (sintering temperature: 800° C.) exhibits a particle size distribution that approximates that of a sintering temperature of 600° C. FIG. 1(b) shows the results of investigating the relationship between sintering temperature and catalyst particle size (mean particle size). Catalyst particle size becomes small in the vicinity of 600° C., and above 600° C., catalyst particle size tends to increase the higher the sintering temperature. Catalyst particle size also increases at sintering temperatures below 600° C. Based on FIGS. 1(a) and 1(b), it was determined that by suitably selecting a sintering temperature within a range lower than 800° C., the mean particle size of catalyst particles can be adjusted to a desired size of 100 nm or less.

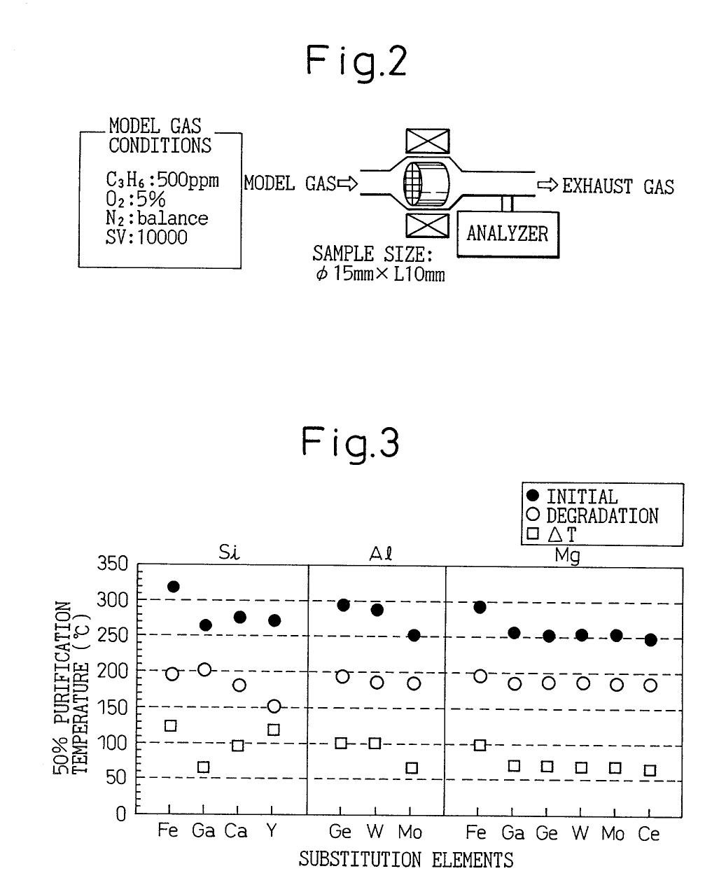

FIG. 1(c) shows the results of investigating the relationship between catalyst mean particle size adjusted in this manner and purification performance. Here, the 50% purification temperature is used as a parameter for evaluating purification performance, and as shown in FIG. 2, together with disposing a sample of ceramic catalyst body for purification performance evaluation (size: φ15×L 10 mm) within an exhaust pipe and introducing a model gas containing hydrocarbons (HC), the temperature of the sample was gradually increased to determine the HC purification rate as calculated from the equation shown below. The temperature at which this HC purification rate is 50% was taken to be the 50% purification temperature.

HC purification rate=[Amount of carbon of incoming HC−Amount of carbon of outgoing HC]/[Amount of carbon of incoming HC]×100

On the basis of FIG. 1(c), the smaller the catalyst mean particle size, the greater the improvement in purification performance, and for a catalyst mean particle size of 100 nm or less, the 50% purification temperature was 300° C. or below, and for a mean particle size of 50 nm or less, the 50% purification temperature was 200° C. or below. In particular, the 50% purification temperature was determined to become low within the range of 10-35 nm. In this manner, by reducing catalyst particle size, the movement of catalyst particles due to thermal vibration or the movement of other catalyst particles is suppressed. Accordingly, there is less occurrence of aggregation, thereby making it possible to improve purification performance.

However, as shown in FIG. 1(b), when a thermal degradation test was conducted at 1000° C. for 24 hours, a trend was observed in which particle size increased slightly, and is presumed to be the result of movement by the slight amount of large particles contained as well as weakly bonded particles. Therefore, it is preferable to remove these weakly bonded particles (for example, those having a bonding force of 0.1 eV or less (1000° C. or below)) in advance by applying chemical, physical or electromagnetic force following loading of catalyst. Examples of specific methods that can be employed include acid treatment, electrical treatment, magnetic treatment as well as the application of vibrations or pressure. As a result of this treatment, thermal degradation inhibitory effects can be enhanced and initial performance can be maintained, thereby improving heat resistance. In contrast, since the γ-alumina itself that coats the ceramic support undergoes a phase change and deteriorates, as shown in FIG. 1(b), the catalyst particle size of the conventional ternary catalyst changes considerably before and after the thermal degradation test, thereby making it difficult to prevent thermal degradation even by using the above treatment and controlling catalyst particle size.

Here, a discussion is presented regarding the substitution elements for forming pores serving as defects in the ceramic support. In the above FIGS. 1(a) through 1(c), although a ceramic support was used in which the Al constituent element of the cordierite was substituted with W, as shown in FIG. 3, ceramic supports were also produced in which the Al was substituted with Ge and Mo instead of W, that in which Si was substituted with Fe, Ga, Ca and Y, and that in which Mg was substituted with Fe, Ga, Ge, Mo, W and Ce (the substitution ratios were 10 wt % in all cases), and the initial performance, purification performance after thermal degradation and their differences (degradation temperature difference: ΔT) are also shown. As a result, initial performance was roughly equal in all cases, and satisfactory purification performance was obtained. Moreover, differences in degradation temperature difference ΔT were observed depending on the substitution element. In particular, in order to reduce the decrease in performance caused by thermal degradation, Ga should be used as the substitution element for Si, Mo as the substitution element for Al and at least one of Ge, W or Ce as the substitution element for Mg, and ΔT can be made to be about 70° C. or lower.

In addition, in order to highly disperse the catalyst component over the entire surface of the support, the pores serving as defects should be uniformly disposed over the entire ceramic support surface. In order to uniformly disperse a large number of defects at equal intervals, compounds of substitution elements are added and mixed in the liquid state without mixing in powder during preparation of the cordierite raw material. For example, in the case of substituting a portion of the Al source with W among cordierite raw materials consisting of talc, kaolin, alumina and so forth, an aqueous solution such as an aqueous solution of ammonia metatungstenate is used for the W compound, which is then added to and kneaded into the raw materials with binder to form a honeycomb shape. The product of drying this at 90° C. for 6 hours should then be sintered for 2.5 hours at 1300° C. or higher. When a solution is used in this manner, since the desired compound is added in ionic form as compared with mixing of particles, a highly dispersed state results entirely at the atomic level, thereby resulting in the pores serving as defects being formed more uniformly.

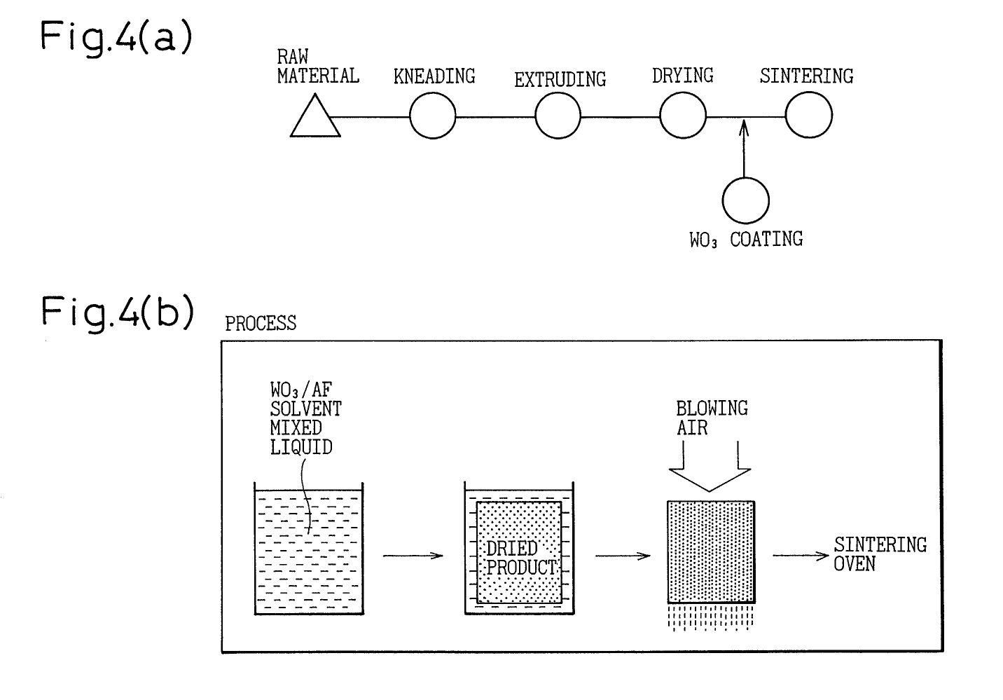

When defects formed in a ceramic support are disposed in a concentrated manner in the surface layer portion of the support, the pores can be used more effectively. In the case of forming defects by substitution of a metal element and allowing those defects to serve as pores, the only defects that contribute to loading of the catalyst component are the defects opening onto the support surface. Accordingly, these defects should only be formed in the surface layer portion of the support, and in order to accomplish this, a compound of a substitution element is added prior to sintering the ceramic support as shown in FIG. 4(a). In other words, when preparing the cordierite raw material, after kneading, extruding and drying without adding the substitution element compound, the substitution element compound, such as a solution containing WO₃, should be coated to form a coated film followed by sintering of the coated film. More specifically, as shown in FIG. 4(b), the dried product following formation is immersed in a mixed liquid (suspension) of WO₃ and dry solvent followed by blowing with air and sintering in an oven. As a result of sintering, a reaction starts from the surface on which the coating is formed, thereby enabling a large number of defects to be formed efficiently in the surface layer portion of the base ceramic.

What is claimed is:

1. A ceramic catalyst body wherein a catalyst component is loaded onto a ceramic support having a large number of pores that enable the catalyst to be loaded directly onto a base ceramic surface, wherein the mean particle size of the catalyst particles is 100 nm or less.

2. The ceramic catalyst body according to claim 1, wherein the mean particle size of the catalyst particles is 50 nm or less.

3. The ceramic catalyst body according to claim 1, wherein the pores are comprised of at least one type of defect in the ceramic crystal lattice, microcracks in the ceramic surface and deficiency in an element that composes the ceramic.

4. The ceramic catalyst body according to claim 3, wherein the width of the microcracks is 100 nm or less.

5. The ceramic catalyst body according to claim 3, wherein the diameter or width of the pores is 1000 times or less the diameter of the catalyst ions that are loaded, and the number of the pores is 1×10¹¹/L or more.

6. The ceramic catalyst body according to claim 3, wherein the base ceramic has cordierite for its main component, and the pores are comprised of defects formed by substituting a portion of the constituent elements of the cordierite with a metal element having a different valence.

7. The ceramic catalyst body according to claim 6, wherein the defects are composed of at least one type of oxygen defect and lattice defect, and 4×10⁻⁶% or more of cordierite crystals having one or more defects are contained in the unit crystal lattice of the cordierite.

8. A ceramic support having a large number of pores that enable a catalyst to be loaded directly onto a base ceramic surface, wherein the base ceramic has cordierite for its main component, and a metal element that is substituted for constituent elements of the cordierite is at least one type selected from Fe, Co, Ti, Zr, Ga, Ca, Y, Mo, Ge, W and Ce.

9. The ceramic support according to claim 8, wherein among the specific constituent elements of the cordierite, at least one type of Fe, Co, Ga, Mo or W is used as the substitution element of Si, at least one type of Ti, Ge, Zr or Mo is used as the substitution element of Al, and at least one type of Fe, Ga, Ge, Mo, Ce or W is used for the substitution element of Mg.

10. A ceramic support having a large number of pores that enable a catalyst to be loaded directly onto a base ceramic surface, wherein the base ceramic has cordierite for its main component, and a metal element that is substituted for constituent elements of the cordierite is at least one type selected from transition metals.

11. The ceramic support according to claim 10, wherein the transition metal is at least one type selected from Ca, Ti, Cr, Mn, Fe, Co, Ni, Cu, Zn, Ga, Ge, Sr, Y, Zr, Nb, Mo, In, Sn, Ba, La, Ce, Pr, Nd, Hf, Ta and W.

12. The ceramic catalyst body or ceramic body according to claim 1, wherein the large number of pores are disposed evenly on the surface of the base ceramic.

13. The ceramic catalyst body or ceramic body according to claim 1, wherein the large number of pores are disposed concentrated on the surface layer portion of the base ceramic.

14. A ceramic catalyst body wherein a catalyst component is loaded onto the ceramic support according to claim 8.

15. The ceramic catalyst body according to claim 1, wherein those catalyst particles of the catalyst that bond weakly with the support are removed in advance.

16. A method for producing a ceramic support having a large number of pores that enable a catalyst to be loaded directly on a base ceramic surface, said method comprising: forming defects to serve as the pores by substituting a portion of the constituent elements of the base ceramic with metal elements having a different valence, and after adding and mixing a solution of the metal elements having a different valence to the starting material of the base ceramic, the base ceramic is sintered to obtain the ceramic support.

17. A method for producing a ceramic support having a large number of pores that allow a catalyst to be loaded directly on a base ceramic surface, said method comprising: forming defects to serve as pores by substituting a portion of the constituent elements of the base ceramic with metal elements having a different valence, and after drying the extruded product of the base ceramic, a coated film containing the metal elements having a different valence is formed on its surface followed by sintering to obtain the ceramic support.

18. A method for producing a ceramic catalyst body comprising loading a catalyst onto a ceramic support having a large number of pores that enable a catalyst to be loaded directly onto a base ceramic surface, wherein after loading the catalyst particles, those catalyst particles that weakly bond with the support are removed by applying chemical, physical or electromagnetic force.
